(19) United States
(12) Patent Application Publication
(10) Pub. No.: US 2013/0027556 A1
(43) Pub. Date: Jan. 31, 2013

(54) SYSTEM AND METHOD FOR SECURITY ZONE CHECKING

(71) Applicants: Jeffrey W. Clark, Brownsburg, IN (US); Robert Pfeffer, Avon, IN (US); Ivo Prikryl, Miami, FL (US); J. John Moder, Miami, FL (US); Armando J. Perez, Miami, FL (US)

(72) Inventors: Jeffrey W. Clark, Brownsburg, IN (US); Robert Pfeffer, Avon, IN (US); Ivo Prikryl, Miami, FL (US); J. John Moder, Miami, FL (US); Armando J. Perez, Miami, FL (US)

(21) Appl. No.: 13/191,177

(22) Filed: Jul. 26, 2011

(51) Int. Cl. H04N 7/18; G08G 1/123

(52) U.S. Cl. 348/148; 340/989; 348/E07.085

(57) ABSTRACT

A system and method of tracking a trailer is provided. The system sends location requests and in response receives the location of the trailer. If the trailer is outside of a virtual fence, it generates an alert.

### BACKGROUND AND SUMMARY

Vehicles, and the cargo that the vehicles may carry, have value and loss by theft or robbery may impact, for example, insurance rates and operating costs. Moreover, the safety of vehicle operators or cargo handlers may also be at risk while the cargo and vehicle are in route to the destination. For at least these reasons, a system to track vehicles and/or cargo, and to report deviations from a pre-planned route, may be important to ensure the safety of the operators, the vehicles, and the cargo.

According to one aspect of the present invention, a method of creating a vehicle security zone fence is provided including receiving vehicle route information including route data indicative of a vehicle route; receiving location data from the location system; generating a plurality of security zones based on the route data; comparing the location data with one or more of the plurality of security zones; and generating an alert condition if the location data is outside of one or more of the plurality of security zones.

According to another aspect of the present invention, a method of monitoring cargo is provided, including: receiving location data from a location system travelling with the cargo at an interval; altering the interval based on a dynamic condition of the vehicle, comparing the location data with the vehicle route; and generating an alert condition if the location data indicates that the cargo is away from the vehicle route.

According to another aspect of the present invention, a method of monitoring a vehicle is provided including providing a vehicle having a tractor and a trailer with a plurality of cameras positioned to capture images of a plurality of sides of the vehicle, receiving location data from a location system associated with the vehicle; and tracking the location of the vehicle based on the location data; and receiving video from the cameras of the tracked vehicle.

### BRIEF DESCRIPTION OF THE DRAWINGS

The foregoing aspects and many of the attendant features of the present disclosure will become more readily appreciated as the same become better understood by reference to the following detailed description when taken in conjunction with the accompanying drawings.

FIG. 1 is a diagrammatic view of a tractor and trailer and a tracking system that includes a monitoring system that tracks the location of the tractor, trailer, and or cargo in the trailer;

FIG. 2 is a diagrammatic view of the tracking system of FIG. 1 including a monitoring system and a location system,

FIG. 3A is a view of a route from location A to location B showing portions of a virtual fence including a plurality of zones along the route;

FIG. 3B is a diagrammatic view of a portion of the route showing a portion of the virtual fence having an edge or boundary;

FIG. 4 is a diagrammatic view of the monitoring system;

FIG. 5 is a diagrammatic view of a route within a city;

FIG. 6 is a diagrammatic view of the location system;

FIG. 7 shows an exemplary method for creating and monitoring a security zone fence according to an embodiment of the present disclosure;

FIG. 8 shows an exemplary method for receiving and responding to location queries according to an embodiment of the present disclosure; and

FIG. 9 is a diagrammatic top view of a tractor and trailer including the location system.

Corresponding reference characters indicate corresponding parts throughout the several views. The exemplifications set out herein illustrate exemplary embodiments of the disclosure and such exemplifications are not to be construed as limiting the scope of the disclosure in any manner.

### DETAILED DESCRIPTION OF THE DRAWINGS

The embodiments of the disclosure described herein are not intended to be exhaustive or to limit the disclosure to the precise forms disclosed. Rather, the embodiments selected for description have been chosen to enable one skilled in the art to practice the subject matter of the disclosure. Although the disclosure describes specific configurations of a tracking system, it should be understood that the concepts presented herein may be used in other various configurations consistent with this disclosure.

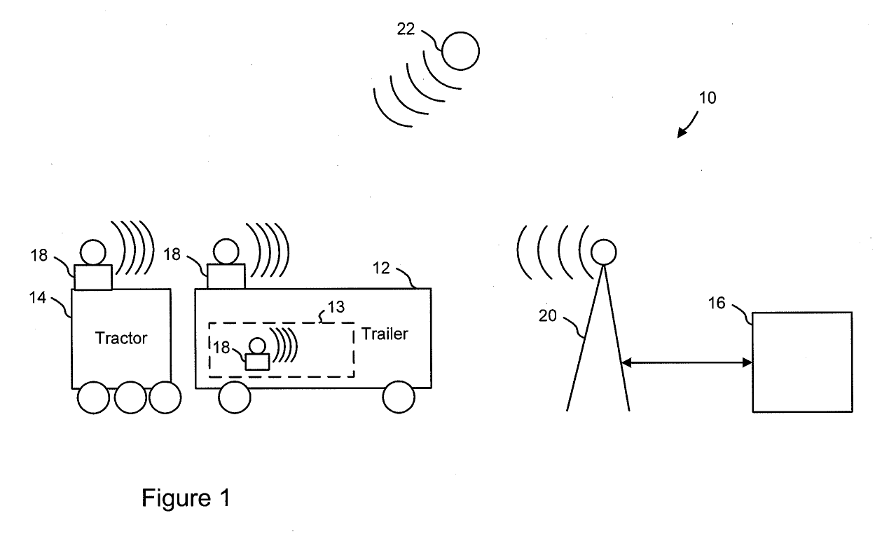

As shown in FIG. 1, according to the present disclosure, a tracking system 10 is provided that tracks the location of trailers 12, their cargo 13, and/or tractors 14 hauling trailers 12. Tracking system 10 includes a monitoring system 16 located at a monitoring center that receives the location of tractors 14, cargo 13, and/or trailers 12 over a communications network 20 and compares the location of tractors 14, cargo 13, and/or trailers 12 to a predetermined route. If a tractor 14, cargo 13, and/or trailer 12 deviates from its predetermined route, monitoring system 16 detects the deviation and provides an alert.

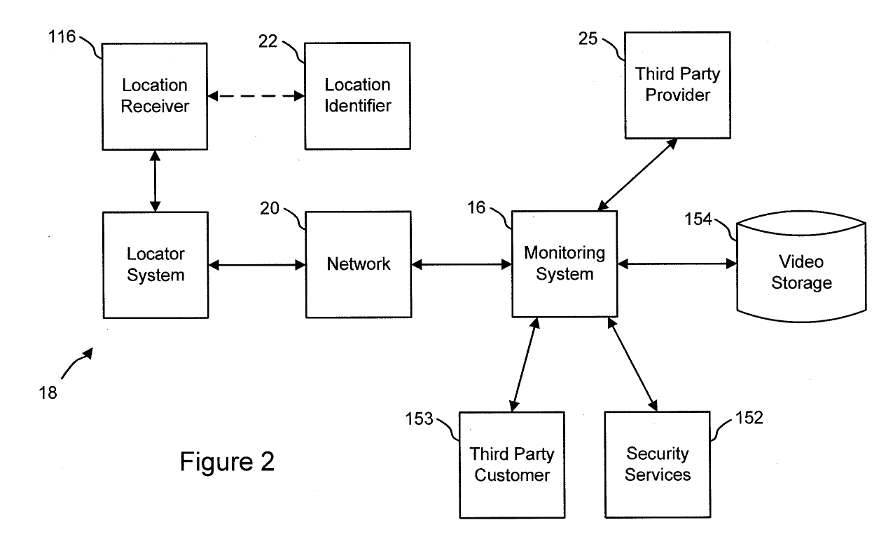

Tracking system 10 also includes location systems 18 coupled to tracked tractors 14, cargo 13, and/or trailers 12 having cargo 13 of interest. Periodically, location systems 18 use one or more signals from a location identifier 22 (shown in FIG. 2), such a GPS satellite system, to calculate their location. Satellite system 22 may be, for example, one or more of a constellation of GPS satellites, each of the satellites broadcasting information used to calculate position. Location systems 18 triangulate their position using these signals from the satellites and send location data to monitoring system 16 via network 20. If for any reason location systems 18 inside cargo 13 (and/or tractors 14 and trailers 12) loses the ability to receive GPS satellite signals needed to triangulate position, monitoring system 16 can detect a less precise location of cargo 13 by knowing which cellular tower (shown as 20 in FIG. 1) location systems 18 is locked onto on the cellular network, which should be the nearest or one of the nearest cellular towers 20. By knowing the nearest cellular tower 20, monitoring system 16 can at least determine a rough location of cargo 13 when the GPS signal is lost or otherwise.

According to the preferred embodiment of the present disclosure, network 20 uses gprs and/or text messaging protocol to send data between location systems 18 and monitoring system 16. The location data may be transmitted to monitoring system 16 in an encrypted manner, or may be transmitted to monitoring system 16 in an unencrypted manner, or only specific portions of the location data may be transmitted in an encrypted manner, with the remainder of the location data transmitted in an unencrypted manner.

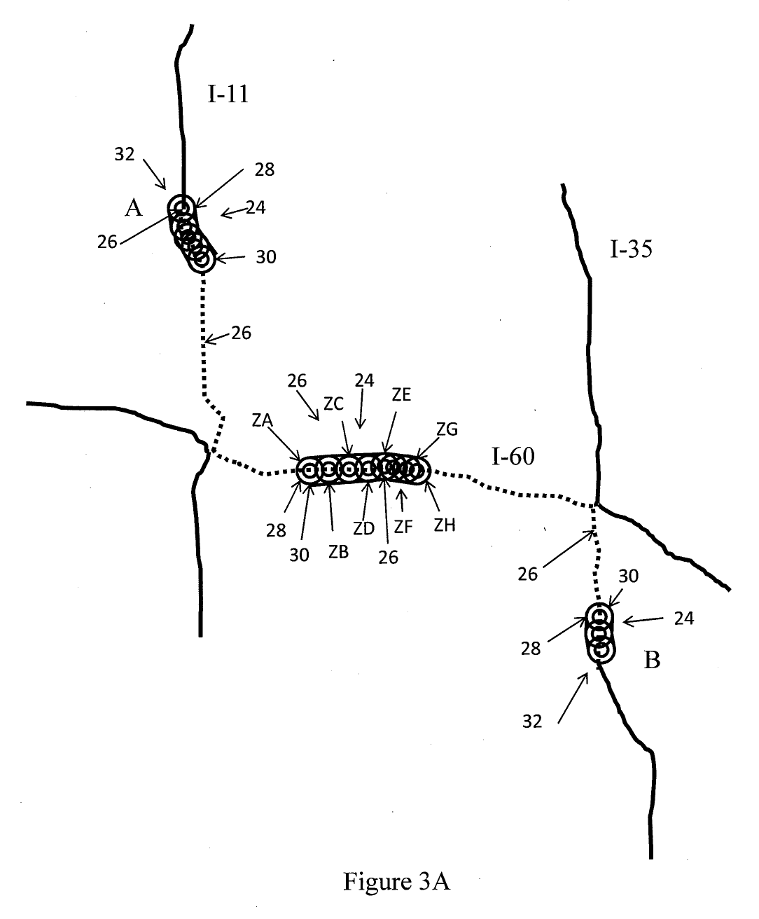

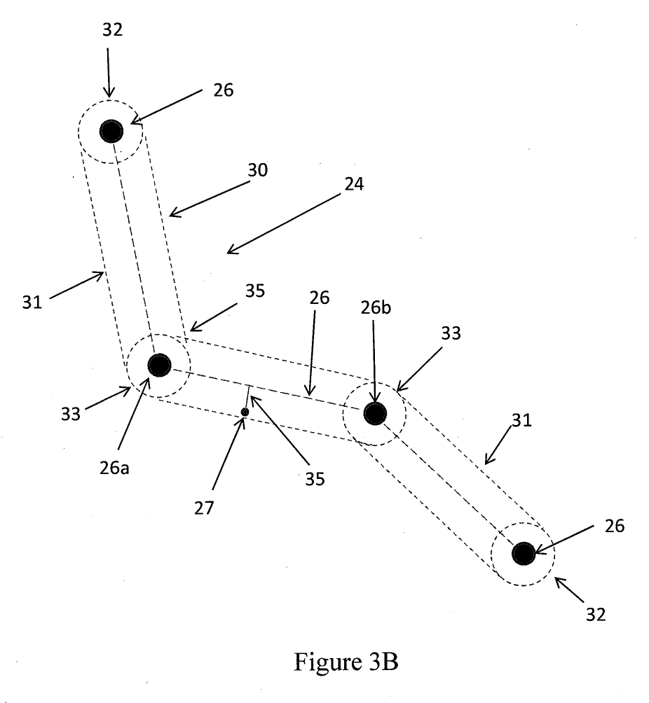

To determine if tractor 14, cargo 13, and/or trailer 12 deviates from the predetermined route, monitoring system 16 compares the respective locations to a pre-planned route. This comparison results in a virtual security zone fence 24 (only portions shown in FIG. 3A) having a set of security zone coordinates using a virtual road map for tractor 14 (and cargo 13 and trailer 12) as shown in FIG. 3A. If tractor 14, cargo 13, and/or trailer 12 are not within virtual fence 24, monitoring system 16 determines that respective tractor 14, cargo 13, and/or trailer 12 has deviated from the predetermined route and may be in danger of theft.

To create a virtual fence, a user provides the pickup location(s) of the cargo (location A on FIG. 3A) of the cargo and the destination(s) of the cargo (location B on FIG. 3A). With this information, monitoring system 16 requests a route from location A to location B. Preferably monitoring system 16 requests the route from location A to location B from a third-party provider 25, such as Google® maps. According to alternative embodiments, the request is made to an in-house route provider, such as mapping software.

In an example as shown in FIG. 3A, third party provider 25 provided a route that begins at location A, travels south on I-11, east on I-60, and south on I-35 to location B. The provided route includes a plurality of geographic coordinate points 26 between location A and location B following the respective portions of I-11, I-60, and I-35. Geographic coordinate points 26 are illustrated as dots in FIG. 3A and may be provided as a series of longitude and latitude data points and may also include altitude. Only portions of virtual fence 24 are shown in FIGS. 3A and 3B. Although only shown on portions of the route from location A to location B, zones 28 that define virtual fence 24 extend along the entire route.

A portion of virtual fence 24 is shown in FIG. 3B. Monitoring system 16 determines which of two the coordinate points 26 are nearest the reported location 27 of respective tractor 14, cargo 13, and/or trailer 12 (ex. coordinate points 26a, 26b in FIG. 3B) Monitoring system 16 calculates a line segment 29 between these closet coordinate points 26a, 26b. Next, monitoring system 16 determines the shortest distance 35 between reported location 27 and line segment 29. If distance 35 is greater than a predetermined length, such as 100 meters, monitoring system 16 provides an alarm because the tractor 14, cargo 13, and/or trailer 12 is beyond an acceptable distance or deviation from the predetermined route. According to an alternative embodiment of the present disclosure, monitoring system 16 determines if the reported location 27 is within a predetermined distance of the closest coordinate point 26. If the reported location 27 is not within the predetermined distance, monitoring system 16 provides an alert. According to this embodiment, zones 28 are circular and overlap defining a virtual fence having scalloped edges.

The result of determining the closest coordinate points and determining if the shortest distance from the reported location 27 to the line segment 29 is within an acceptable range is virtual fence 24, which is effectively a series of zones 28 around adjacent pairs of coordinate point 26. Most, if not all of these zones 28 have straight portions 31 and circular portions 33 centered on each coordinate point 26 and having a radius equal to the predefined acceptable distance (ex. 100 meters). These straight 31 and circular portions 33 cooperate to define an edge or boundary 30 of virtual fence 24. Because some zones 28 overlap, some portions of edge 30 define non-arcuate corners 35 as compared to acuate corners at circular portions 33. Circular portions 33 at ends 32 are half circles compared to the other circular portions that are less than half circles. Collectively, these zones 28 define virtual fence 24 along the route. According to alternative embodiments of the present disclosure, the zones around each coordinate point may be other shapes, such as squares, ovals, or other shapes known to those of ordinary skill in the art which may also provided scalloped edges.

Although shown in FIGS. 3A and 3B for illustrative purposes, monitoring system 16 need not actually display a virtual fence or even calculate the boundaries of virtual fence 24. However, the net result of the calculations and comparisons described above is a virtual fence 24 that if a tractor 14, trailer 12, and/or cargo 13 go outside of virtual fence 24, monitoring system 16 will trigger an alert.

As described in greater detail below, monitoring system 16 tracks tractors 14, cargo 13, and/or trailers 12 to determine if they go outside of this virtual fence 24. In order to not deviate from the route, tractors 14, cargo 13, and trailer 12 should be positioned within the predetermined distance of a line segment 29 defined between adjacent coordinate points 26 or stated differently positioned within in at least one of zones 28. If monitoring system 16 detects that tractor 14, cargo 13, and/or trailer 12 is not within the predetermined distance of at least one of line segments 29 (or within at least one of zones 28), it determines that respective tractor 14, cargo 13, and/or trailer 12 is outside of fence 24 and provides an alert.

Because tractor 14, cargo 13, and/or trailer 12 are typically moving when being monitored, the location of tractor 14, cargo 13, and/or trailer 12 are updated frequently. At intervals of time, each respective location system 18 of tractor 14, cargo 13, and/or trailer 12 determines its current location. According to one embodiment, location systems 18 on tractor 14 and trailer 12, use intervals of time, detected speed, and/or changes in direction to determine which of these determined locations are sent to monitoring system 16 via network 20 as discussed herein. According to one embodiment, location systems 18 receive the GPS data every second, but only send the then current location at the given reporting interval of time or other triggering event, such as change of direction or speed. The non-reported locations can be saved or discarded. According to one embodiment, location system 18 in cargo 13 does not use change of direction to determine when to send location data. In an alternative embodiment, monitoring system 16 sends commands to location systems 18 requesting its location, and location systems 18 send location data or other data in response to the request.

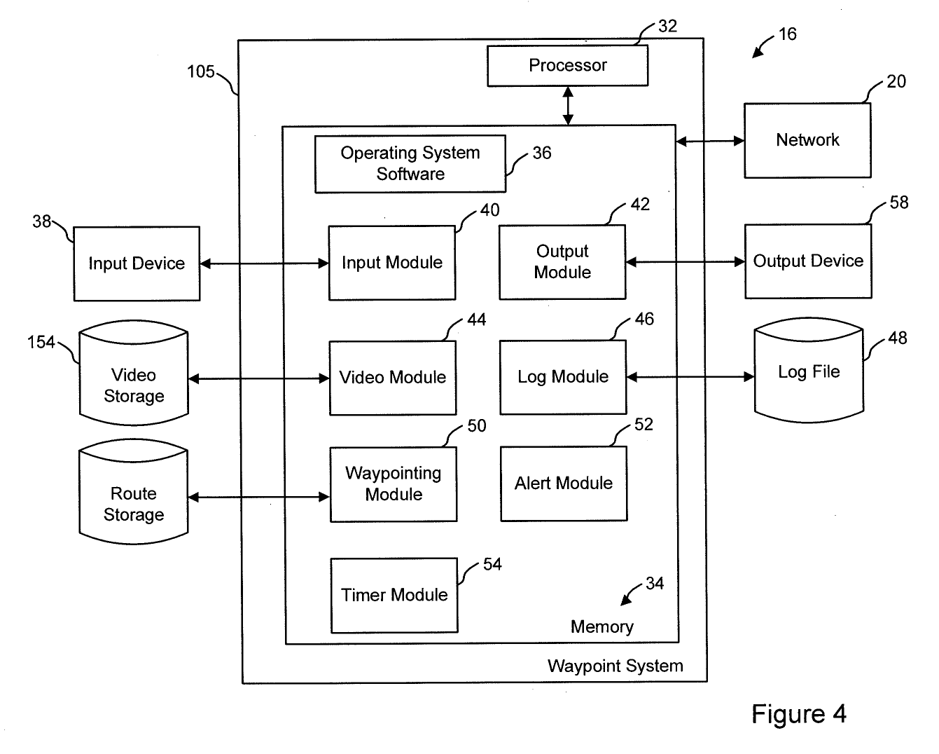

Each system 16, 18 includes a plurality of hardware and/or software components that facilitate their functionality. FIG. 4 provides additional details of monitoring system 16 according to an embodiment of the present disclosure. Monitoring system 16 includes a processor 32, memory 34 containing operating system software 36, input devices 38, and a plurality of software and/or hardware modules including an input module 40, an output module 42, a video module 44 in communication with one or more cameras on tractor 14 and/or trailer 12, a log module 46 in communication with a log file 48, a security zone module 50 that monitors the location of trailer 12, an alert module 52, and a timer module 54. Although each module is described as present in monitoring system 16, one or more modules may not be present, depending on the desired functionality of monitoring system 16. For example, if no cameras or sensors are present on tractor 14 and/or trailer 12, then video module 44 may also not be present.

The modules described herein may be in communication with other systems and/or databases that may operate either in the same physical computer system as location system 18 or monitoring system 16, or may operate on one or more separate physical computer systems. In one embodiment, location system 18 is a single system and monitoring system 16 is a single system. In another embodiment, location system 18 (or monitoring system 16) is two or more systems in communication with each other.

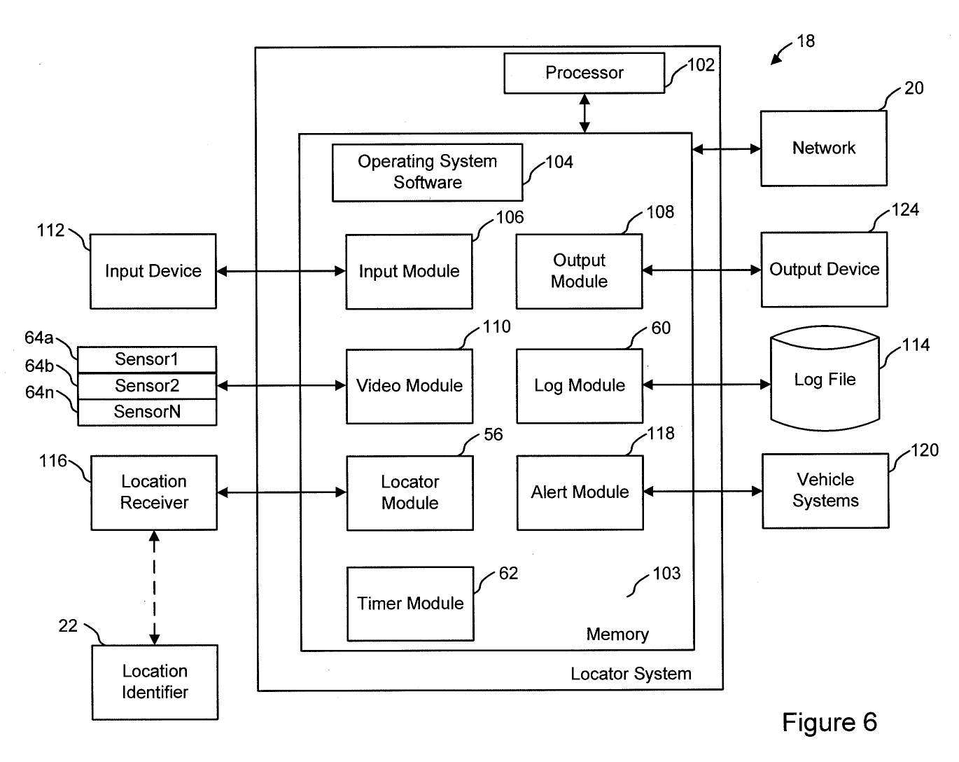

Input module 40 receives information from users through input devices 38 such as a locator module 56 of location system 18 (shown in FIG. 6), third parties, security providers, and other sources of input. Preferably, input module 40 receives input over network 20 in the form of electronic signals. Additional examples of input devices 38 include, but are not limited to: computer mice, track pads, keyboards, touch screens, and sensors, such as those on tractor 14 and/or trailer 12 or other sensors.

Output module 42 transmits information received from one or more of the modules of monitoring system 16 to one or more output devices 58. One output device 58 is network 20, which may be the same network 20 used as an input device 38, or may be a different network 20. Other examples of output devices 58 include, but are not limited to: television screens, computer monitors, and printers.

Video module 44 receives data from sensors 64a-64n or other modules of location system 18. Video module 44 may also transmit commands to location system 18 to transmit data or cease transmitting data from one or more of the one or more sensors 64a-64n, so that one or more of the sensors 64a-64n may be selectively activated or deactivated. The data from location system 18 may be stored in video storage 154, to allow for later recall. Video module 44 may display data from one or more of sensors 64a-64n at a display, and may, for example, highlight sensor data if an alarm condition exists.

Preferably, security zone module 50 receives inputs from a user and/or from a third party and calculates the route coordinates for the security zone fence. Security zone module 50 receives the pickup/beginning location (location A in FIG. 3) and destination/end location (location B in FIG. 3) from a user or third party 25. Security zone module 50 sends a route request with this information to a third party system 25. The third party system calculates a suggested route that is the shortest route or fastest route, and transmits the information in the form of coordinate points 26 to security zone module 50. The route calculation may also include additional variables, such as speed limits along the suggested route, current or predicted weather along the suggested route, tolls, current or predicted road construction, or other variables that influence a shortest or fastest route or conditions along the suggested route. The user may modify the suggested route and request and receive updated coordinate points 26 based on the modification. For example, if the user knows or suspects that portions of the suggested route are in areas prone to theft, the user may modify the suggested route to steer clear of these theft-prone areas. In response to the modification, the third party then provides updated coordinates 26 and related information reflecting the modifications.

The third party provider 25 and/or monitoring system 16 may calculate the security coordinates 26 based on one or more factors. For example, the coordinates 26 may be created at intervals along the selected route. These coordinates 26 may be created along the planned route at 10 meter intervals, 20 meter intervals, or any other intervals. The interval may be the same throughout the planned route, or the interval may change along the planned route. The interval may be longer along stretches of road with no exits or fewer exits, such as an interstate highway. For example, more coordinates 26 may be provided on portions of a route (i.e. the coordinates are spaced closer together) where it is more likely for tractor 14, cargo 13, and/or trailer 12 to potentially deviate from the route, as is possible if roads intersect or more than one road may be chosen, such as in, for example, exits along an interstate highway. On portions of the route with little chance of a deviation, such as long stretches of an interstate between exits, fewer coordinates 26 may be provided (i.e. the coordinates are spaced further apart).

Timer module 54 includes a timer that allows monitoring system 16 to optionally request location data from location system 18 at intervals of time if the system is configured for monitoring system 16 to make location request. For example and if so configured, monitoring system 16 may request location data every ten seconds, or every thirty seconds, or over any other time interval. In addition to requesting the location on a period passes, someone at the monitoring system 16 may manually enter a request for the current location of a particular location system 18 as identified by its specific identification (ex. phone number and password). In response to this request, the particular location system 18 sends its current location. According to one embodiment of the present disclosure, timer module 54 may adjust the time interval based on differing conditions, such as the location of tractor 14, cargo 13, and/or trailer 12 (ex. near an intersection), the threat level of an area (ex. high theft city), or otherwise.

Log module 46 stores data received from location system 18, video module 44, input module 40, alert module 52, and/or the other modules. The log modules described therein, such as log module 46 and log module 60 of location system 18 may also store the time of one or more events with data from timer modules, such as timer modules 54, 62. The log modules may store the data as a cache until the data is transmitted to another system, or the log module may store the data on a permanent or semi-permanent basis on removable memory, or may include an interface to transfer the data to another system via, for example and without limitation, a network 20 or a dedicated connection to another system.

The log files, such as log file 48, discussed herein use a relational database to store the data. In another embodiment, the log files use other structures to store the data. For example, the log file may include data stored in a hierarchical data structure, a flat file data structure, or another type of data structure that may allow the storage and recall of data.

Alert module 52 generates an alert condition based on information received from location system 18 and security zone module 50. The information received from location system 18 may include information that indicates that location system 18 is in violation of one or more rules associated with the security zone coordinates 26, such as one or more of tractor 14, cargo 13, or trailer 12 being more than the predetermined distance from all of coordinate points 26 (i.e. outside of fence 24). Similarly, if location system 18 detects that an unauthorized event at tractor 14, cargo 13, or trailer 12 has occurred (ex. unauthorized driver of tractor 14, drastic speed change, unauthorized movement of cargo 13 relative to trailer 12, unauthorized opening of the trailer door,), location system 18 may send data to monitoring system 16 that such an event has occurred.

When alert module 52 sends an alert, monitoring system 16 notifies human monitors of the alert. For example, a human monitor at a monitoring center may receive notification of the alert. Along with this notification, the human monitor may be provided with streaming video from trailer 12 (discussed in greater detail below) so the human monitor can visually determine the status of trailer 12. For example, if the human monitor sees someone approaching or entering trailer 12, they may notify a local security service 152 that a potential or actual theft is underway and also provide the location of trailer 12 (ex. at mile marker 12 on I-60) based on the data provided by location system 18.

As mentioned above, one example of a rules violation is if location system 18 indicates that the current location is outside of the security zone fence described above. According to one embodiment, alert module 52 may have a built in tolerance for rule violations. For example, on occasion the provided location may be inaccurate enough to provide a false indication as to whether trailer 12 is within fence 24. To compensate for this inaccuracy, alert module 52 may not provide an alarm indication for one time rule violations. If the rule violation is repeated, alert module 52 may provide an alarm. For example, if the location of trailer 12 falls outside of fence 24 for two consecutive intervals, an alarm will be generated. If the location of trailer 12 falls outside fence 24 once and is followed up with a location 12 within fence 24 on the next interval, no alarm will be generated.

According to one embodiment, alert module 52 may anticipate the next security zone(s) along the route. If trailer 12 is not in the anticipated zone(s) 28, alert module 52 generates an alert condition. For example, a route including a series of zones including zone ZA through zone ZH that have center coordinates that are 150 feet apart and zone radii of 150 feet. Alert module 52 knows a preferred range of speeds (ex. 55-75 mph) of trailer 30 along the portion of the route that includes zones ZA-ZH shown in FIG. 3A. Knowing the preferred range of speeds and the distance between each zone's coordinate center 26, alert module 52 can predict which zones 28 trailer 12 should be within as is travels the route. For example, if trailer 12 has a preferred range of speeds of 55-75 mph on the portion of route including zones ZA-ZH, it should travel 80 to 110 feet per second. If the interval for location requests is 4 seconds, trailer 12 should travel 323-440 feet between location requests. If trailer 12 starts within zone ZC at either far end of zone ZC, it should at least travel to zone ZD even at the slowest speed of 55 mph and could possibly travel as far as zone ZG at the fastest speed of 75 mph. Thus, if trailer 12 is located in any zone 28 other than zones ZD through zone ZG, alert module 52 could send an alert. As a result, as trailer 12 travels along the prescribed route the virtual fence 24 moves with trailer 12. Put another way, portions of virtual fence 24 become authorized (i.e. trailer 12 should be located within that portion of fence 24) and unauthorized (i.e. trailer 12 should not be located within that portion of fence 24 or anywhere outside of fence 24).

In addition to knowing if trailer 12 is outside of an authorized portion of fence 24, alert module 52 can glean additional information based on which zone 28 (ex. zones ZA-ZH) trailer 12 is located. If trailer 12 is still in zone ZC in the above example, alert module knows that trailer 12 is moving too slow or has potentially stopped. If trailer 12 is in zone ZH, alert module 52 knows that trailer 12 is travelling too fast. If trailer 12 is in zone ZA, alert module 52 knows that trailer 12 is travelling in direction opposite of what is should be travelling. In addition to or as an alternative, alert module 52 may calculate the speed (distance over time) and direction (coordinate comparison) of travel between the two most recently reported locations using the indicated locations at each interval and the time between each interval.

Other examples of violations may include, but are not limited to: a speed violation, indicating that location system 18 is going faster or slower than the posted speed limit for its location, an unapproved vehicle stop while location system 18 is on an approved route, a direction violation, indicating that the vehicle is within the approved security zone fence 24 but is proceeding in the opposite direction of approved travel, an unapproved vehicle stopping point, the activation of a panic button, which may be activated by the driver of tractor 14 associated with location system 18, an unapproved driver, if the driver is approved by a code and/or biometric sensor, an unauthorized freight door opening, unapproved freight entering the trailer or cargo carrying space of a vehicle, freight exiting the trailer at an incorrect stopping point, a denial of service attack against location system 18 or associated wired or wireless sensors 64a-64n of location system 18, such as cameras, accelerometers, etc. an unapproved disconnection of trailer 12 from tractor 14, erratic driving conditions, such as weaving or speed differences, or the activation of one or more sensors 64a-64n that may indicate collision, such as with an accelerometer or audio sensor. Alert module 52 may transmit signals indicating the alert condition to third party systems.

Third party customer 153 may include one or more systems to interface with monitoring system 16. The third party systems may transmit security zone information to monitoring system 16, along with, for example, a unique identifier for a specific location system 18 or group of location systems. Monitoring system 16 may monitor specific location system 18 or group of location systems, and may send data, including location data and/or other data, to the third party systems. Monitoring system 16 may also send data to the third party systems to indicate an alert event or events, and may receive data from the third party systems in relation to the alert event or events.

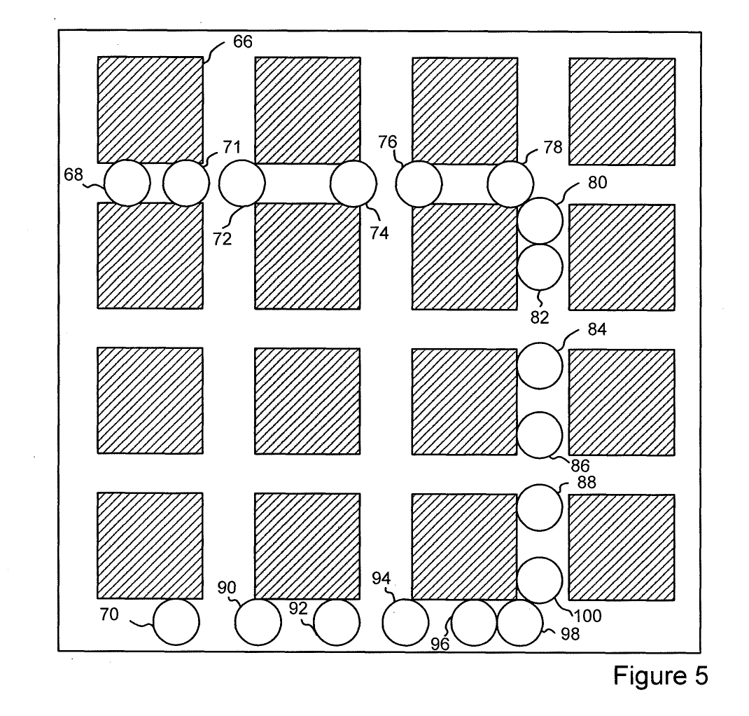

FIG. 5 shows another exemplary location-based coordinate points 26 in a city with buildings 66 according to an embodiment of the present disclosure. (For clarity, zones 28 are not shown in FIG. 5, but extend around the line segments 29 between adjacent pairs of coordinate point 26 at a predetermined distance as described above). In the exemplary figure, the route begins around coordinate 68 and ends around coordinate 70. The distance between coordinates 26 may be selected based on the location of the route where an opportunity to deviate from the approved route may be taken. For example, coordinates 71 and 72 are closer together than coordinates 72 and 74, as a vehicle may deviate from the approved route between coordinates 71 and 72, but may not be able to deviate from the approved route between coordinates 72 and 74. Similarly, coordinates 78, 80, and 82 are closer together, as the turn may allow a vehicle more opportunity to deviate from the approved route. Similarly, coordinates 84, 86, and 88, and coordinates 90, 92, and 94 are more spread out, while coordinates 96, 98, and 100 are closer together, indicating another turn in the route. Similarly or as an alternative, locations systems 18 may adjust the reporting rate as intersections come and go as discussed above.

FIG. 6 shows a component view of location system 18 according to an embodiment of the present disclosure. Location system 18 in the illustrative embodiment includes a processor 102 and memory 103 containing operating system 104 software, an input module 106, an output module 108, a video module 110 in communication with one or more cameras, log module 60 in communication with a log file 114, locator module 56 in communication with a location receiver 116, an alert module 118 in communication with vehicle systems 120, and timer module 62. Log module 60 stores data received from locator module 56, video module 110, input module 106, and/or alert module 118.

In the illustrative embodiment, input module 106 receives information from users, the security zone module, third parties, or security. Input module 106 may receive input over a network 20 in the form of electronic signals. In an embodiment, input module 106 receives data from network 20, and rearranges or reprocesses the data so that it may be transmitted to other modules in location system 18. Other examples of input devices 62 include, but are not limited to: computer mice, trackpads, keyboards, touch screens, sensors 64a-64n including video sensors 64a-64n. In an embodiment, an alert condition exists if an input device 62 is connected or disconnected from location system 18.

In the illustrative embodiment, output module 108 transmits information received from one or more of the modules of location system 18 to one or more output devices 124. In an embodiment, output device 124 is a network 20, which may be same network 20 used as an input device 62, or may be a different network 20. Other examples of output devices 124 include, but are not limited to: television screens, computer monitors, and printers. In an embodiment, an alert condition exists if an output device 124 is connected or disconnected from location system 18.

Locator module 56 receives signals from the locater receiver. The signals may be data received from GPS satellite system 22 that relate to the position of location receiver 116. Locator module 56 may receive the signals from location receiver 116 and calculate the position if location receiver 116, if the signals received from GPS satellite system 22 do not directly reveal the position of location receiver 116. In an embodiment, locator module 56 may also calculate the location of location system 18, if the location of location system 18 is different than the location of location receiver 116. In an embodiment, an alert condition exists if locator module 56 does not receive signals from the locator receiver, and/or if the locator receiver does not receive signals from GPS satellite system 22.

Timer module 122 may include a timer. As discussed above, location system 18 periodically sends its location to monitoring system 16. As such, timer 122 allows location system 18 to send location data to monitoring system 16 over an interval or intervals. For example, location system 18 may send location data to monitoring system 16 every ten seconds, or every thirty seconds, or over any other interval. The interval may be adjusted by location system 18 according to an input from a user or from monitoring system 16, or from another third party system. For example, if location system 18 knows that it is in a high theft area or in an area in which deviations from the route may occur, the interval rate may be decreased so that less time goes by during location reporting. Similarly, when location system knows that it is a low theft area or in an area with no deviations from the route (ex. between interstate exchanges), the interval rate may be increased so that more time goes between reporting.

According to one embodiment of the present disclosure, location system 18 sends its location based on the speed of tractor 14, trailer 12, and/or cargo 13 to which each particular location system 18 is mounted. For example, if tractor 14, trailer 12, and/or cargo 13 is travelling below a first speed (ex. 10 KPH), location systems 18 report their location at a certain time interval (ex. every three minutes). During this interval, location systems 18 may report multiple locations that it determined during the three minute interval so the route during the interval can also be monitored for irregularities, such as route deviations. If tractor 14, trailer 12, and/or cargo 13 is travelling within a range of speeds (ex. between 10 KPH and 60 KPH), location systems 18 report their location every time tractor 14, trailer 12, and/or cargo 13 change direction by more than a predetermined amount (ex. 12 degrees) or whenever they travel a predetermined distance (ex. every 500 meters). If tractor 14, trailer 12, and/or cargo 13 is travelling above a range of speeds (ex. above 60 KPH), location systems 18 report their location every time tractor 14, trailer 12, and/or cargo 13 change direction by more than another predetermined amount (ex. 10 degrees) or whenever they travel another predetermined distance (ex. every 1000 meters). These reporting parameters can be adjusted depending on the route, type of cargo, or any other factor.

Location systems 18 may also send a location report if they detect that tractor 14, trailer 12, and/or cargo 13 are not moving. If monitoring system 16 detects that location system 18 is not moving it may or may not send an alarm. For example, along a route, it may be permissible for a tractor 14, trailer 12, and cargo 13 to come to a stop (ex. approved fueling centers, weight stations, etc.). If monitoring system 16 detects that location system 18 has stopped within a predetermined distance of a preapproved location, it will not issue an alert. However, if it has stopped in an a non-approved location, monitoring system 16 will issue an alert.

Monitoring system 16 may also adjust the timing of location reporting. For example, monitoring system 18 may request that locations system 18 report their location every 30 seconds regardless of their speed. According to one embodiment of the present disclosure, locations system 18 on tractor 14, trailer 12, and cargo 13 may send location reports at different intervals or in response to different conditions. For example, location system 18 embedded in cargo 13 may only report its location based on time (ex. every minute), whereas locations system 18 on the trailer 12 in which that particular cargo 13 is stored and the tractor 14 that is hauling that particular trailer 12 report based on changes in direction or distance travelled as discussed above. Similarly, if location system 18 embedded in cargo 13 detects that cargo 13 is not moving, it may only report its location at longer intervals than if moving. For example, if the location system 18 in cargo 13 detects movement (ex. from an accelerometer) it may report at a shorter interval (ex. every minute), but if it doesn't detect movement (ex. no change in position from the last reported location), it may report its location at a longer interval (ex. every hour). During these timed intervals, the GPS antenna of location systems 18 may be turned off.

Alert module 118 may receive an alert condition from, for example and without limitation, monitoring system 16 or other system, and may interact with one or more vehicle systems 120 to generate an alert, or may interact with other modules to generate an alert. For example, alert module 118 may be in communication with vehicle electrical systems, and, on receiving an alert condition from monitoring system 16, may disable the vehicle's electrical system to disable the vehicle. If alert module 118 disables the vehicle on receiving an alert condition, the disablement may occur in a way that allows the vehicle to slow and stop safely. In another embodiment, alert module 118 may generate an alert for an output device 124. The alert, for example and without limitation, may include an audio, visual, or tactile alert from one or more of output devices 124.

Location receiver 116 may be an antenna to receive signals from one or more additional location identifiers 22, such as signals from GPS satellite system 22 and uses the signals to calculate the position of location receiver 116, location system 18, and trailer 12. System 22 may use other methods of location identification to provide, refine or augment location information, such as cell towers, etc.

Although each module is described as operating within location system 18, one or more modules may not be present, depending on the functionality desired of location system 18. For example, if no video sensors 64a-64n are present, then video module 110 may also not be present.

In the illustrative embodiment, location system 18 includes one or more input devices 112, one or more output devices 124, one or more processors 102, and memory associated with the one or more processors 102. The memory associated with the one or more processors 102, 32 described herein may include, but is not limited to, memory associated with the execution of the associated modules, and memory associated with the storage of data.

Monitoring and location systems 16, 18 may also be associated with one or more networks 20, and may communicate with one or more additional systems via the one or more networks 20. The modules may be implemented in hardware or software, or a combination of hardware and software. Monitoring and location systems 16, 18 may also include additional hardware and/or software to allow systems 16, 18 to access the input devices, the output devices, the processors, the memory, and the modules. For example, operating systems 36, 104 may allow modules or other systems to access input devices 38, 62, output devices 54, 124, processors 32, 102, the memory, and/or the other modules. Operating system software may also allow one or more of the modules, or other processes in execution on monitoring and location systems 16, 18, to access one or more networks 20. In an embodiment, the modules, or a combination of the modules, are associated with different processors 32, 102 and/or memory, for example on distinct systems, and the systems are located separately from one another. In another embodiment, the modules are executed on the same system as one or more processes or services. The modules may be operable to communicate with one another and to share information. Although the modules are described as separate and distinct from one another, the functions of two or more modules may instead be executed in the same process, or in the same system.

In an embodiment, location system 18 may be powered by a connection to a vehicle. In another embodiment, location system 18 (ex. in cargo 13) may be self-powered by, for example and without limitation, a battery of any type or a renewable resource, such as solar power. In another embodiment, location system 18 may be powered by both a connection to a vehicle and be self-powered, with one of the power connections being a primary and the other being a backup to the primary. An alert condition may exist if the power from a power source is interrupted (e.g, the power source is disconnected or fails).

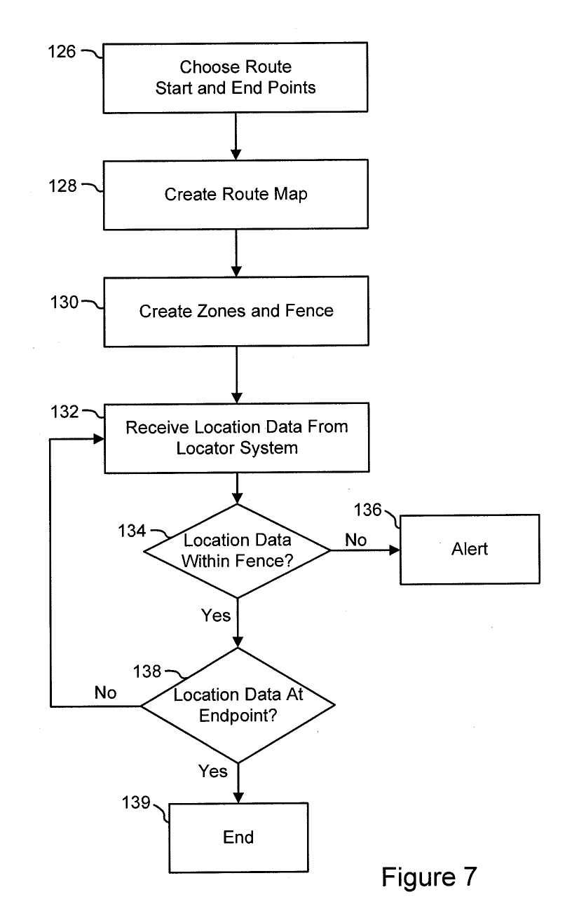

FIG. 7 shows an exemplary method for creating and monitoring a security zone fence 24 according to an embodiment of the present disclosure. In box 126, a user at monitoring system 16 chooses a start point and an end point. In box 128, a route is selected by a third party, such as Google® maps. As mentioned above, the route may be selected by the third party from a plurality of possible routes based on one or more criteria which may include, for example and without limitation, the shortest distance between two points, or the shortest travel time between two points. The route calculation may also include additional variables, such as speed limits, current or predicted weather, tolls, current or predicted road construction, or other variables to influence a shortest or fastest travel time. Monitoring system 16 may be programmed to indicate preferences for any of the additional variables. As part of the creation of the route, coordinates 26 are provided along the route for use in creating security zone fence 24.

As mentioned above, coordinates 26 may be determined by conditions along the route. Third party 25 then transmits the coordinates to monitoring system 16 over network 20. As mentioned above, monitoring system 16 may also receive coordinates 26 from an in-house source rather than from a third party 25. In step 130, the security zone fence 24 is created by generating the zones 28 around each coordinate 26.

When coordinates 26 are determined, location system 18 may be activated. Monitoring system 16 may transmit commands to location system 18 to activate sensors 64a-64n, if any, associated with location system 18, and may activate other functions associated with location system 18. For example, monitoring system 16 may authorize location system 18 to start the vehicle, or may authorize one or more sensors 64a-64n or scanners to accept input from one or more drivers, so that the drivers may input a code, or may present a feature for a biometric lock, in order to gain access to the vehicle or control the vehicle. Sensors 64a-64n may communicate with monitoring system 16 to receive information and authenticate the driver or other authorized individual or individuals. Monitoring system 16 may arm location system 18, so that deviations from security zone fence 24 or other rules violations may trigger an alarm condition.

In optional box 132, monitoring system 16 may send one or more commands to location system 18, such as a request that location system 18 send location data. The commands may occur at predetermined intervals, or may occur at any frequency, including at a frequency determined at least in part by the security zone coordinates 26 in security zone fence 24. For example, if there are several coordinates close together indicating a potential point of deviation from the predetermined route, monitoring system 16 may send location requests at a shorter interval. Similarly, when tractor 14 and trailer 12 return to a portion of the route have fewer or no likely points of deviation along the route, monitoring system 16 will increase the time interval between locations requests to location system 18. Location system 18 responds to the location requests with location data, which may include the location of location system 18 or the location of the vehicle, and may also include additional information. As discussed in greater detail above, monitoring system 16 may not send locations request, but rather location systems 18 automatically send their location based at time intervals or based on sensed conditions (ex. change in direction, distance travelled, etc.).

In box 134, monitoring system 16 compares the location data received from location system 18 with security zone fence 24 (i.e. calculates if the reported location is within a predetermined distance of line segment 29 between the two closets coordinate points according to one embodiment of the present disclosure). If the location data indicates that the location is outside of security zone fence 24, then monitoring system 16 indicates an alert condition, shown in box 136. As discussed above, monitoring system 16 may determine if location system 18 is within a subset of the zones around the line segments or coordinates (ex. zones ZD through ZG mentioned above).

The acceptable distance from line segments 29 may be individually set for each adjacent pair of coordinate 26 point along the route, or may be set globally and applied to each pair of coordinate points 26 defining line segments 29, or to groups of coordinate points 26. The alert condition may provide a user of monitoring system 16 with pertinent information, including a unique identifier of trailer 12, tractor 14, and/or cargo 13, the expected security zone(s), and the current location presented in the location data. In box 138, if the location data indicates that the vehicle is within security zone fence 24, and the vehicle has not yet reached its destination, then monitoring system 16 returns to box 132 and waits for the next location report (or optionally transmits a location request to location systems 18).

The one or more unique identifiers may include a code specific to location system 18 or trailer 12, tractor 14, and/or cargo 13 (such as a phone number), so that several location systems 18 may transmit location data to monitoring system 16, and monitoring system 16 may track several location systems 18 in a simultaneous or nearly simultaneous manner. The one or more unique identifiers may also include a group code, to which one or more location systems 18 may belong. The unique identifier maybe transmitted by the location system 18 with the location or the cell network may automatically indicate the phone number sending the location data, which is then correlated with a tractor 14, trailer 12, and/or cargo associated with the phone number. The location data may also include other status information, for example data collected from one or more of the one or more sensors 64a-64n.

If the vehicle has reached the destination of the route at box 139, monitoring system 16 may alert a user of monitoring system 16 or a third party, such as the cargo owner 153, local police force 152, etc., that the vehicle has reached the destination. Monitoring system 16 may also send one or more signals to location system 18 to deactivate sensors 64a-64n, if any, associated with location system 18, and may deactivate other functions associated with location system 18.

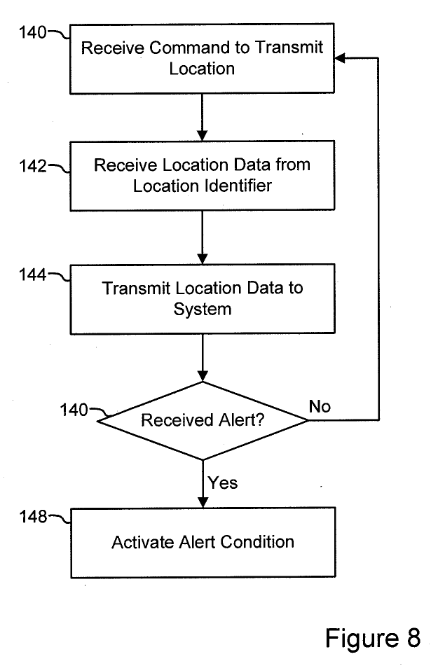

FIG. 8 shows an exemplary method for receiving and responding to location queries according to an embodiment of the present disclosure. In box 140, location system 18 initiates a location determination or optionally may receive a location request from monitoring system 16.

In box 142, GPS satellite system 22 sends a signal or signals to location receiver 116, which receives the signals and, either alone or with the locator module, calculates position data from the signals received from GPS satellite system 22. The position data may identify the position of location receiver 116, and location system 18 may use this position data, or may calculate the position of another point based on the position of location receiver 116 and the position data. The calculations determine the location data.

In box 144, location system 18 transmits the location data to monitoring system 16 via network 20. Location system 18 may also transmit additional information along with the location data, such as, for example and without limitation, the current time or other interval, one or more unique identifiers, one or more group codes, or other status information, including data collected from one or more of one or more sensors 64a-64n.

If location system 18 does not receive an alert condition from monitoring system 16, shown in box 146, location system 18 returns to box 140 and waits until the conditions are satisfied for sending another location report or optionally waits for the next location request from monitoring system 16. If location system 18 receives an alert condition signal from monitoring system 16, location system 18 may activate one or more alert conditions, shown in box 148.

Alert conditions may include, but are not limited to: sounding alarms or flashing lights either at the vehicle, location system 18, monitoring system 16, or a third party system 153. A video feed or camera images may also be displayed in tractor 14 and/or the monitoring center, along with location data and any rules that led to the alarm condition.

The current location may also be displayed, and location and/or other data may be transmitted to security services 152 by monitoring system 16 for further processing, analysis, or action. For example, and without limitation, monitoring system 16 may transmit alert event information to security services 152, and security services 152 may dispatch one or more patrol cars to investigate the alert condition.

In addition to sending location data to monitoring system 16, location system 18 may also transmit data from video or still cameras, recorders, or other sensors to monitoring system 16, and the data may be stored in video storage 154 as discussed below in greater detail. Monitoring system 16 may communicate with one or more third party customers 153, such as the owner of the cargo, to share the location data or other data with the one or more third party customers 153. Monitoring system 16 may communicate with one or more security services 152, if the location data received or other data received from location system 18 indicates an alert condition.

Video storage 154 stores video data and/or other data transmitted from location system 18 via network 20. In an embodiment, video storage 154 uses a relational database to store the data. In another embodiment, video storage 154 uses other structures to store the data. For example, video storage 154 may include data stored in a hierarchical data structure, a flat file data structure, or another type of data structure that may allow the storage and recall of data. In an embodiment, video storage 154 operates on the same system or group of systems on which monitoring system 16 operates as, for example and without limitation, a separate electronic process or processes. In another embodiment, video storage 154 operates on a system that is separate from monitoring system 16, and monitoring system 16 and video storage 154 are in communication via, for example and without limitation, one or more networks 20 or one or more dedicated connections.

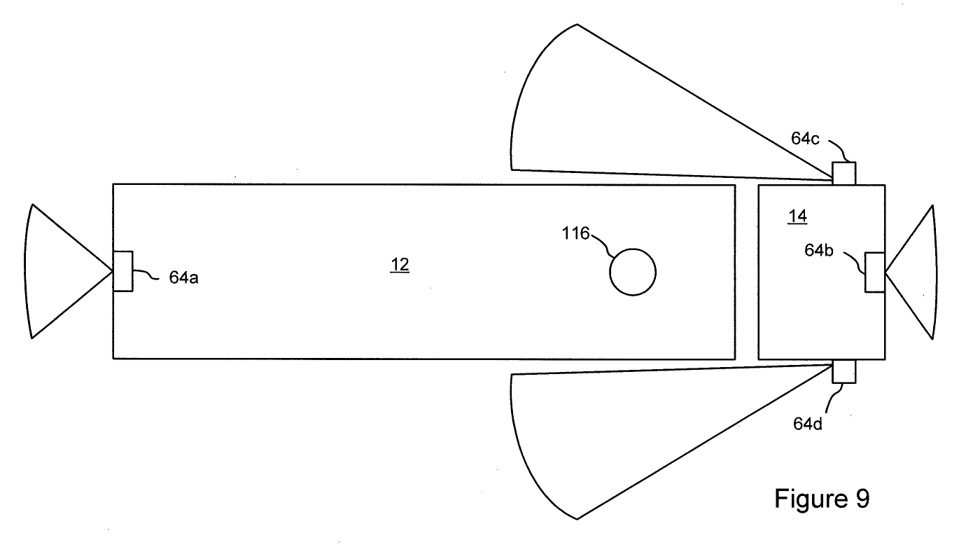

FIG. 9 shows a top view of an exemplary vehicle with a location system 18 according to an embodiment of the present disclosure. The exemplary vehicle in FIG. 3 is a tractor-trailer, but other vehicles may be used, or a location system 18 may be associated with cargo within a vehicle. The locator, in the exemplary figure, is shown in the trailer portion of the tractor-trailer vehicle. Location receiver 116 is shown affixed to the top of the trailer, to receive signals from GPS satellite system 22. Location receiver 116 may be in wired or wireless communication with location system 18. Four video sensors 64a-64d are shown in the exemplary figure. Three video sensors 64b-64d are shown in tractor 14 of the tractor-trailer vehicle, with one video sensor 64b facing forwards and two video sensors 64c, 64d facing towards the rear of the vehicle. A fourth video sensor 64a is also shown in trailer 12 of the tractor-trailer vehicle. Each of video sensors 64a-64d may be in wired or wireless communication with location system 18, or may be in both wired and wireless communication, with one communication method being primary and the other being secondary. All sensors 64a-64n Camera sensors 64a-64d may be powered by the vehicle via, for example and without limitation, the alternator of an engine or one or more batteries used to power the vehicle. Camera sensors 64a-64d may also be self-powered by, for example and without limitation, solar cells or batteries.

In the illustrative embodiment, video module 110 communicates with one or more sensors 64a-64n. Video module 110 receives data from one or more of the one or more sensors 64a-64n and may transmit the data to monitoring system 16. In an embodiment, video module 110 may also receive commands to transmit data or cease transmitting data from one or more of one or more sensors 64a-64n, so that one or more of sensors 64a-64n may be selectively activated or deactivated. In an embodiment, sensors 64a-64n are in wireless communication with video module 110. In another embodiment, sensors 64a-64n are in wired communication with video module 110. In another embodiment, sensors 64a-64n are in both wired and wireless communication with video module 110, with one mode of communication used as a backup if the other mode is interrupted. In an embodiment, the interruption of signal from one or more of the one or more video sensors 64a-64d to video module 110 creates an alert condition. Video module 110 may selectively operate one or more of the one or more video sensors 64a-64n. For example, two or more video sensors 64a-64n may operate to cover a location, with one sensor operating as a backup to the other sensor. If video module 110 does not receive data from the non-backup sensor, video module 110 may attempt to receive data from the backup sensor before transmitting an alert condition. Additionally, video module 110 may receive commands to activate or deactivate one or more of the one or more video sensors 64a-64n. Commands to activate or deactivate video sensors 64a-64n may be transmitted from monitoring system 16, or may be generated by location system 18.

The commands to activate or deactivate video sensors 64a-64n may be, for example and without limitation, in response to the location of location system 18. For example, if location system 18 is in a high risk/theft area, or an area that is prone to incidents, then video sensors 64a-64n may be activated. When trailer 12 leaves the high risk area, then video sensors 64a-64n may be de-activated. At a monitoring station, a human monitor may actively watch the footage from video sensors 64a-64n only when trailer 12 is in a high risk area. To prompt the human monitor to watch the footage, monitoring system 16 may start the display of, enlarge, or otherwise enhance the ability of the human monitor to watch the streamed video when trailer 12 enters a high risk area, or by any other trigger automatically. After trailer 12 leaves the high risk area and enters a lower risk area, monitoring system 16 ends the display of the video, minimizes the video, or otherwise lessens the ability of the human to human monitor to watch the streamed video.

According to an alternative embodiment, video sensors 64a-64n continuously stream the video regardless of where trailer 12 is located, but the human monitors ability to view the streaming video changes with the trailer's location. Human video monitoring based on the location of trailer 12 may require a higher service fee from the customer. According to another embodiment, the human monitor watches the streaming video during the entire route. Such monitoring, and the even higher associated service fee, may be warranted on high value cargo. As such, the human video monitoring may be a function of the value of the cargo. The human monitor can watch for vehicles approaching or stalking trailer 12 or for other suspicious activity.

In an embodiment, video module 110 and/or the one or more video sensors 64a-64n may reduce or increase sensitivity, sample collection frequency, or resolution of one or more of the one or more video sensors 64a-64n. This may occur, for example, to save bandwidth, storage of the data, or to reduce the power demands of video sensors 64a-64n. In an embodiment, the data is stored in storage associated with location system 18. In another embodiment, the data is transmitted to monitoring system 16 or to another system via network 20.

Video sensors 64a-64n are in communication with video module 110, and generate data based on the environment. In an embodiment, a sensor may be a camera to take single frame images of the camera's field of view. In another embodiment, a sensor may be a video recorder to record successive images of the recorder's field of view. In other embodiments, sensors 64a-64n may include audio sensors, thermal or ultraviolet cameras or video recorders, temperature sensors, accelerometers, orientation sensors, bacteriological sensors, radiological sensors, chemical sensors to detect one or more types of substances, or other types of sensors to detect the presence or absence of stimuli.

In an embodiment, location system 18 may also include a radio frequency identification (“RFID”) reader, which can track freight onboard based on when it enters or exits the vehicle. A database may be created to log the item being moved onto or off of the vehicle, when it was moved, where the vehicle was located when it was moved, and, with additional video recorders, an image or movie of the freight being loaded or unloaded from the vehicle. Also a locator such as a GPS device may also be embedded into cargo for tracking cargo separately from location system 18.

In an embodiment, location system 18 may be used to calculate electronic log books for a driver and/or a cargo. A wireless component may allow a driver to display the logbooks on a wireless device, such as, for example and without limitation, a tablet computer, a notebook computer, a smartphone, or other computer device. The driver may provide the electronic logbooks to law enforcement, if requested. Location system 18 and/or monitoring system 16 may also provide date range report capabilities calculating state fuel tax payables.

Location system 18 may integrate with other systems. For example, and without limitation, location system 18 may integrate with hardware and/or tracking devices to track, maintain, log and publish cargo temperatures and set points.

Communications network 20 may include one or more of: a local area network, a wide area network, the Internet, a radio network such as a radio network using an IEEE 802.11x communications protocol, a cellular network, a satellite network, a cable network, a fiber network or other optical network, a token ring network, or any other kind of packet-switched or direct transmission network may be used. The use of the term “network” does not limit the network 20 to a single style or type of network, or imply that only one network is used. A combination of networks of any communications protocol or type may be used. For example, two or more packet-switched networks may be used, or a packet-switched network may be in communication with a radio network.

The memory discussed herein includes computer readable media. Computer-readable media may be any available media that may be accessed by one or more processors 32 of the receiving system and includes both volatile and non-volatile media. Further, computer readable-media may be one or both of removable and non-removable media. By way of example, computer-readable media may include, but is not limited to, RAM, ROM, EEPROM, flash memory or other memory technology, CD-ROM, Digital Versatile Disk (DVD) or other optical disk storage, magnetic cassettes, magnetic tape, magnetic disk storage or other magnetic storage devices, or any other medium which may be used to store the desired information and which may be accessed the system.

While this disclosure has been described as having exemplary designs, the present disclosure can be further modified within the spirit and scope of this disclosure. This application is therefore intended to cover any variations, uses or adaptations of the disclosure using its general principles. Further, this application is intended to cover such departures from the present disclosure as come within known or customary practice in the art to which this disclosure pertains.

What is claimed is:

1. A method of creating a vehicle security zone fence, including:
receiving vehicle route information including route data indicative of a vehicle route;
receiving location data from the location system;
generating a plurality of security zones based on the route data;
comparing the location data with one or more of the plurality of security zones; and
generating an alert condition if the location data is outside of one or more of the plurality of security zones.

2. The method of claim 1, wherein the route data includes a plurality of geographic points and the step of generating the plurality of security zones includes comparing the distances between the location data and a plurality of the geographic points to define the plurality of security zones.

3. The method of claim 2, wherein the comparison include determining the closest geographic points to a location data and calculating the shortest distance between the location data and a line segment between the closest geographic points.

4. The method of claim 2, wherein in the security zones have edges with circular portions centered on each of the plurality of geographic points.

5. The method of claim 1, wherein the step of receiving location data occurs repeatedly at intervals of time.

6. The method of claim 5, wherein the time between intervals is based on the location of the vehicle.

7. The method of claim 5, wherein the time between intervals is based on the route data.

8. The method of claim 5, wherein the time between intervals is based on the speed of the vehicle.

9. The method of claim 5, wherein the time between intervals is based on a change of direction of travel of the vehicle.

10. The method of claim 7, wherein the vehicle route includes an interchange where the vehicle route changes from one thoroughfare to another thoroughfare and the time interval is less while the vehicle is nearer to the interchange.

11. The method of claim 1, further including the step of sending one or more signals to the location system to alter the vehicle in response to an alarm condition being generated.

12. The method of claim 1, wherein an alert condition is generated if the location data indicates the vehicle is travelling in an unapproved direction.

13. The method of claim 1, wherein an alert condition is generated if the location data indicates the vehicle is travelling less than a predetermined speed.

14. The method of claim 13, wherein the predetermined speed is based on the route information.

15. The method of claim 1, wherein an alert condition is generated if an accelerometer in communication with the location system indicates a change of acceleration of the vehicle.

16. The method of claim 1, wherein the alert condition includes informing a third party of the deviation from the one or more of the plurality of security zones.

17. The method of claim 1, wherein the location system includes one or more video sensors, and further including the step of receiving video data from one or more of the one or more video sensors.

18. The method of claim 17, further including the step of displaying a portion of the video data if an alert condition is generated.

19. The method of claim 1, further comprising the step of providing a beginning coordinate and a destination coordinate, wherein the route information is calculated based on the beginning coordinate and the destination coordinate.

20. A method of monitoring cargo, including:
receiving location data from a location system travelling with the cargo at an interval;
altering the interval based on a dynamic condition of the cargo,
comparing the location data with a vehicle route; and
generating an alert condition if the location data indicates that the cargo is away from the vehicle route.

21. The method of claim 20, wherein vehicle route includes route data having a plurality of geographic points and the step of comparing step includes calculating a distance from the vehicle to the vehicle route based on the plurality of geographic points.

22. The method of claim 21, wherein in the calculated distance is the shortest distance between a line segment between two adjacent geographic points.

23. The method of claim 20, wherein the vehicle route includes an interchange where the vehicle route changes from one thoroughfare to another thoroughfare and the time interval is less while the vehicle is nearer to the interchange.

24. The method of claim 20, wherein the location system is supported by a tractor hauling the cargo.

25. The method of claim 20, wherein the location system is embedded with the cargo.

26. A method of monitoring a vehicle including:
providing a vehicle having a tractor and a trailer with a plurality of cameras positioned to capture images of a plurality of sides of the vehicle,
receiving location data from a location system associated with the vehicle;
tracking the location of the vehicle based on the location data; and
receiving video from the cameras of the tracked vehicle.

27. The method of claim 26, further comprising the steps of
comparing the location data with a predetermined vehicle route and
generating an alert condition if the location data indicates that the vehicle is away from the vehicle route.

28. The method of claim 27, further comprising the step of
remotely monitoring the video based on the generation of an alert condition.

29. The method of claim 26, further comprising the step of
remotely monitoring the video based on the location of the vehicle along the vehicle route.

30. The method of claim 29, wherein the vehicle route includes at least one high security portion and at least one low security portion and the step of monitoring occurs while the vehicle is in the high security portion.
